(19) United States
(12) Patent Application Publication
(10) Pub. No.: US 2011/0113381 A1
(43) Pub. Date: May 12, 2011

(54) MULTIPLE CHECK BOX SUBSET SELECTION

(75) Inventor: David R. Schwartz, Bellevue, WA (US)

(73) Assignee: INTERNATIONAL BUSINESS MACHINES CORPORATION, Armonk, NY (US)

(21) Appl. No.: 12/616,261

(22) Filed: Nov. 11, 2009

(51) Int. Cl. G06F 3/048

(52) U.S. Cl. 715/845

(57) ABSTRACT

A list of elements, each with an associated check box element, is displayed via a graphical user interface (GUI) component on a display. A first GUI event associated with one check box element is detected, where the first GUI event includes a GUI event selected from a group consisting of a check box selection event and a check box clear event. A second GUI event identical to the first GUI event and associated with a second check box element is detected, where at least one other check box element is displayed between the one check box element and the second check box element via the GUI component. A GUI selection control element is displayed. A GUI event identical to each of the first GUI event and the second GUI event for at least one other check box element is programmatically generated in response to detection of a selection of the GUI selection control element via a user input device.

### BACKGROUND

The present invention relates to computing device user interface controls. More particularly, the present invention relates to multiple check box subset selection.

A variety of information input object types are available for use in conjunction with a computing device graphical user interface (GUI). User input devices allow a user to interact with a GUI to enter information and make selections among optional entry fields and input object types. For example, text entry fields allow entry of text information within a GUI element via a keypad or keyboard. Radio buttons allow selection of an item among a group of alternative selections within a GUI element, such as via a mouse or other pointing device. Check boxes allow selection of an item from a list, also such as via a mouse or other pointing device.

### BRIEF SUMMARY

A method includes displaying a list of elements, each with an associated check box element, via a graphical user interface (GUI) component on a display device; detecting a first GUI event associated with one check box element, where the first GUI event comprises a GUI event selected from a group consisting of a check box selection event and a check box clear event; detecting a second GUI event identical to the first GUI event associated with a second check box element, where at least one other check box element is displayed between the one check box element and the second check box element via the GUI component; displaying a GUI selection control element; and programmatically generating a GUI event identical to each of the first GUI event and the second GUI event for the at least one other check box element in response to detection of a selection of the GUI selection control element via a user input device.

A system includes a display device; a user input device; and a processor programmed to: display a list of elements, each with an associated check box element, via a graphical user interface (GUI) component on the display device; detect a first GUI event associated with one check box element, where the first GUI event comprises a GUI event selected from a group consisting of a check box selection event and a check box clear event; detect a second GUI event identical to the first GUI event associated with a second check box element, where at least one other check box element is displayed between the one check box element and the second check box element via the GUI component; display a GUI selection control element via the display device; and programmatically generate a GUI event identical to each of the first GUI event and the second GUI event for the at least one other check box element in response to detection of a selection of the GUI selection control element via the user input device.

A computer program product includes a computer useable storage medium including a computer readable program. The computer readable program when executed on a computer causes the computer to: display a list of elements, each with an associated check box element, via a graphical user interface (GUI) component on a display device; detect a first GUI event associated with one check box element, where the first GUI event comprises a GUI event selected from a group consisting of a check box selection event and a check box clear event; detect a second GUI event identical to the first GUI event associated with a second check box element, where at least one other check box element is displayed between the one check box element and the second check box element via the GUI component; display a GUI selection control element via the display device; and programmatically generate a GUI event identical to each of the first GUI event and the second GUI event for the at least one other check box element in response to detection of a selection of the GUI selection control element via a user input device.

### BRIEF DESCRIPTION OF THE SEVERAL VIEWS OF THE DRAWINGS

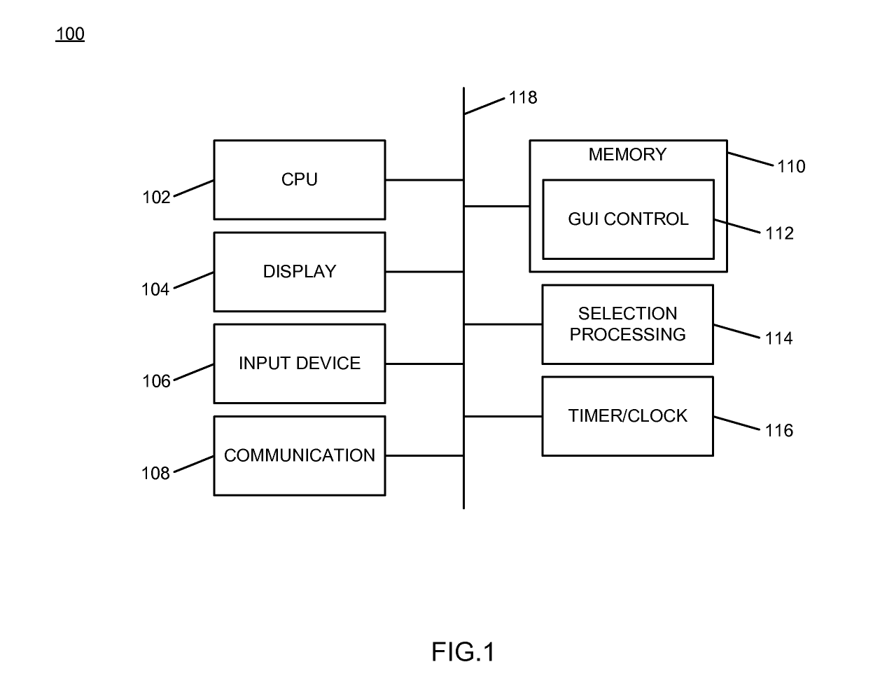

(FIG. 1) is a block diagram of an example of an implementation of a computing device for multiple check box subset selection according to an embodiment of the present subject matter;

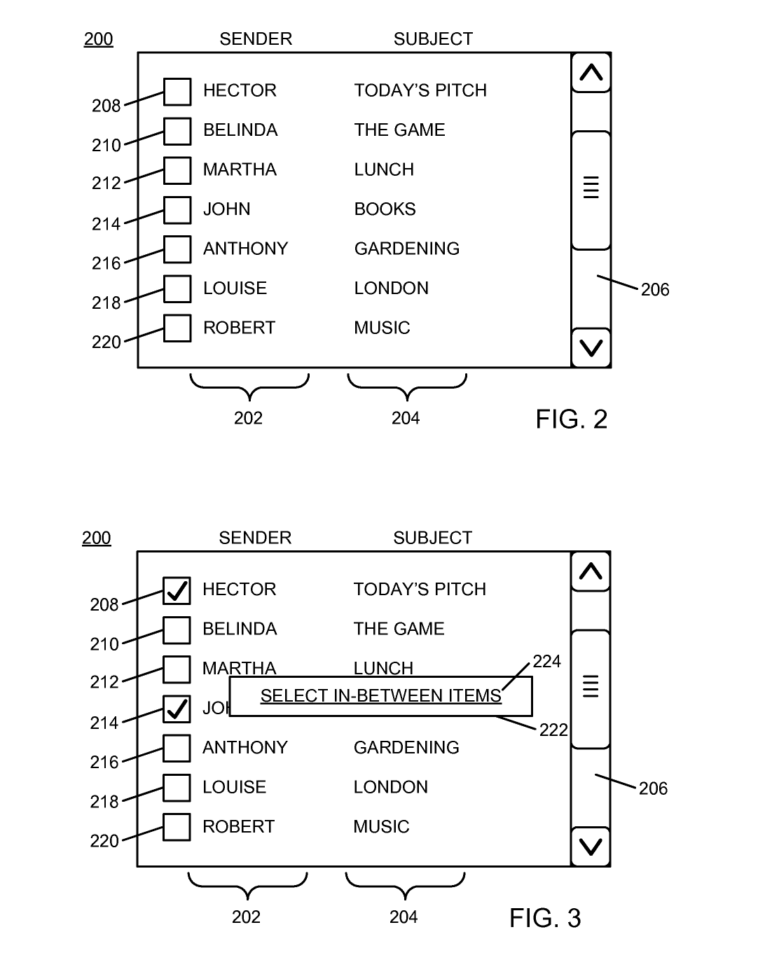

(FIG. 2) is an illustration of an example of an implementation of an email graphical user interface (GUI) that includes a listing of received emails in an initial state of processing where all list elements are de-selected (e.g., cleared) according to an embodiment of the present subject matter;

(FIG. 3) is an illustration of an example of an implementation of the email GUI of FIG. 2 in a subsequent state of processing after the computing device has detected two identical GUI selection events associated with the email GUI according to an embodiment of the present subject matter;

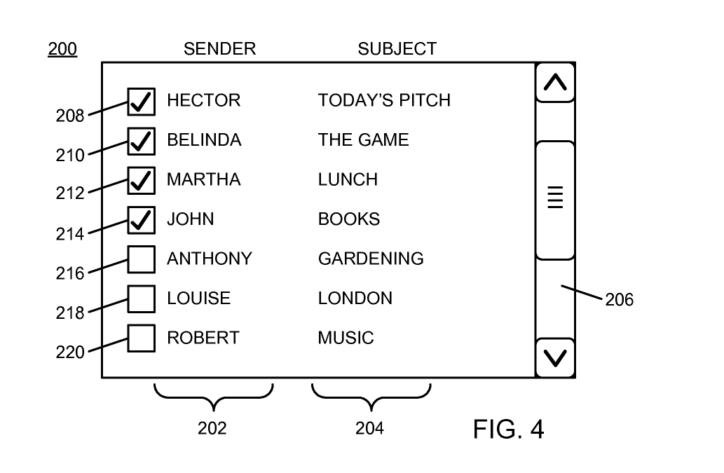

(FIG. 4) is an illustration of an example of an implementation of the email GUI of FIG. 3 in a subsequent state of processing after the computing device has detected a selection of the GUI selection control element illustrated within FIG. 3 according to an embodiment of the present subject matter;

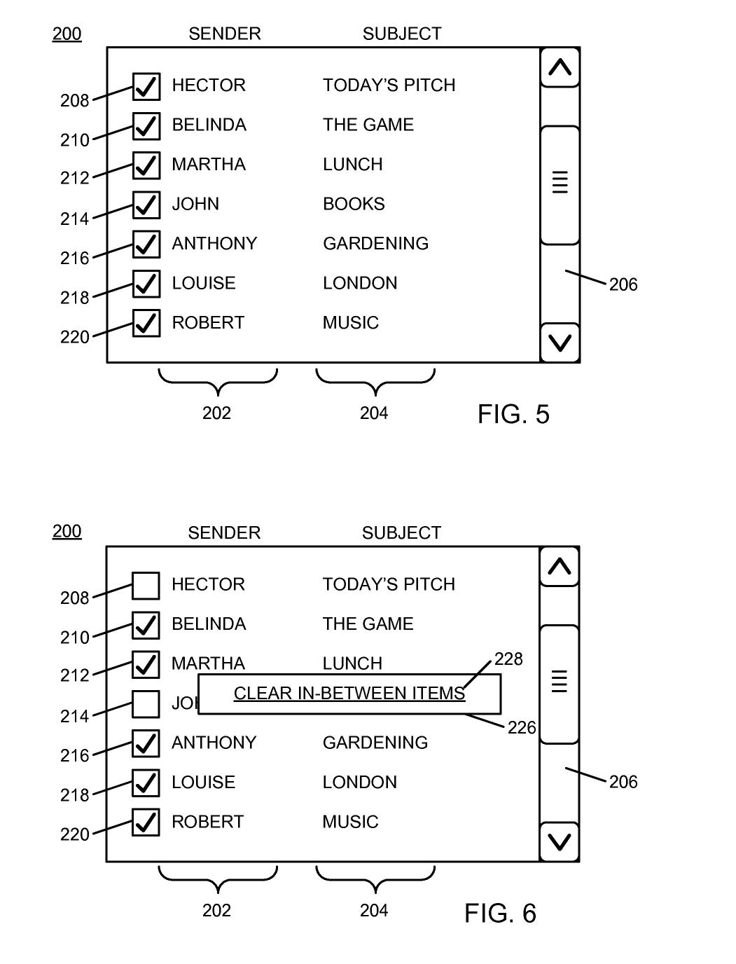

(FIG. 5) is an illustration of an example of an implementation of the email GUI, originally depicted in FIG. 2, that includes a listing of received emails in an initial state of processing where all list elements are selected according to an embodiment of the present subject matter;

(FIG. 6) is an illustration of an example of an implementation of the email GUI of FIG. 5 in a subsequent state of processing after the computing device has detected two identical GUI de-selection (e.g., clear) events associated with the email GUI according to an embodiment of the present subject matter;

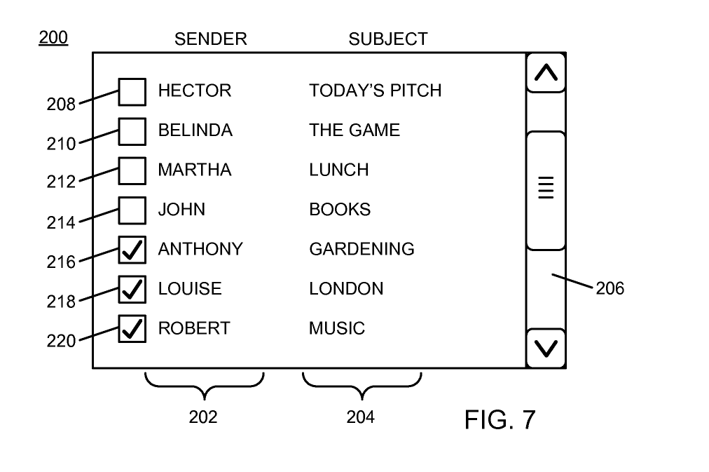

(FIG. 7) is an illustration of an example of an implementation of the email GUI of FIG. 6 in a subsequent state of processing after the computing device has detected a selection of the GUI selection control element illustrated within FIG. 6 according to an embodiment of the present subject matter;

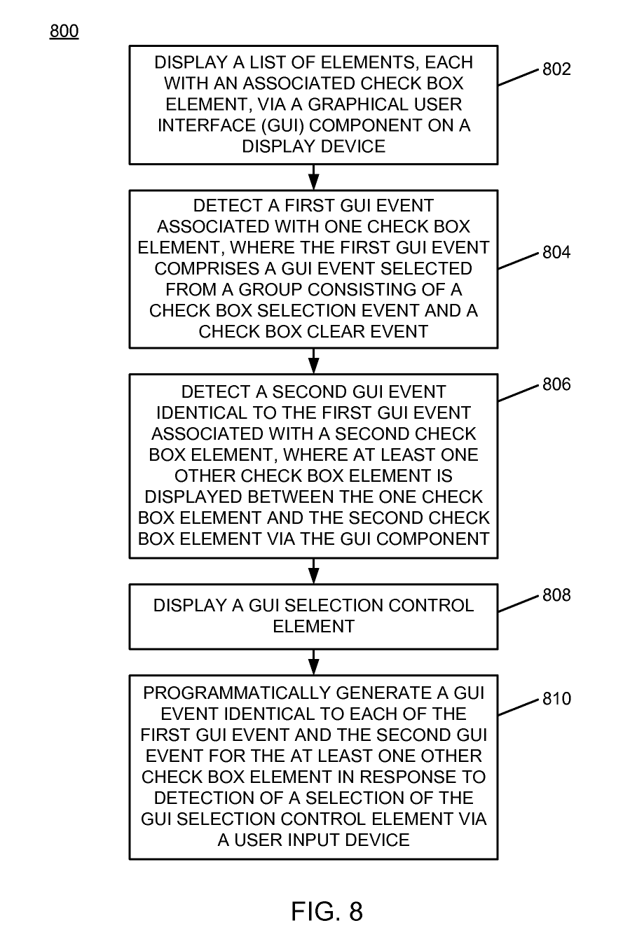

(FIG. 8) is a flow chart of an example of an implementation of a process for automated multiple check box subset selection according to an embodiment of the present subject matter; and

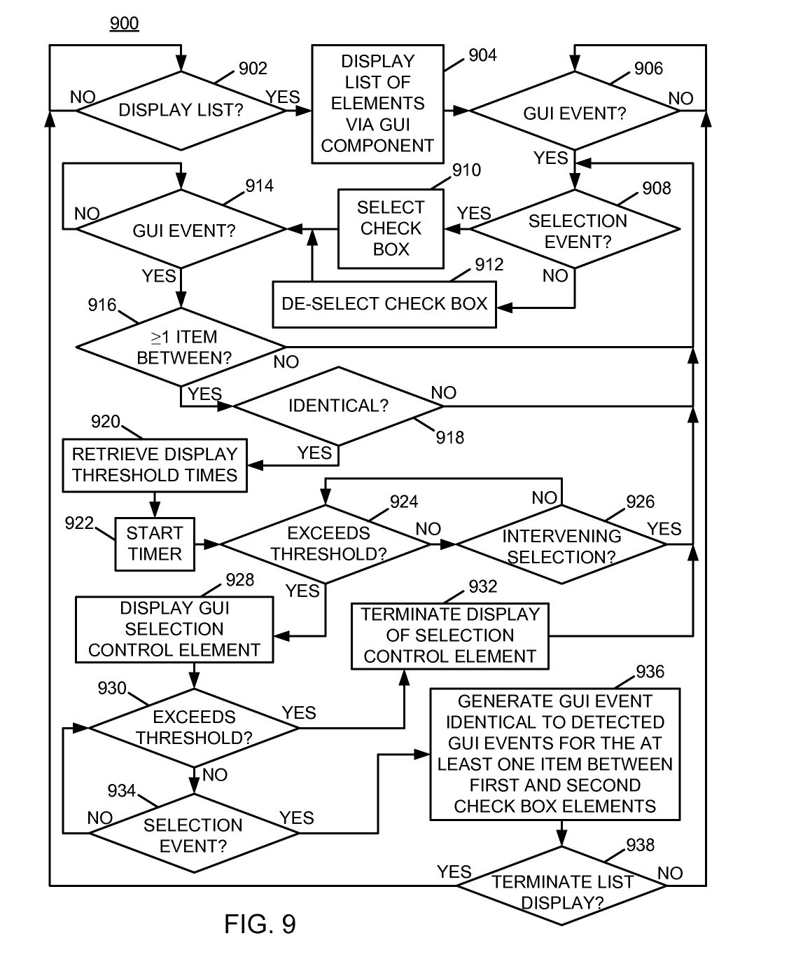

(FIG. 9) is a flow chart of an example of an implementation of a process for multiple check box subset selection without requiring use of an augmenter key according to an embodiment of the present subject matter.

### DETAILED DESCRIPTION

The examples set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The subject matter described herein provides multiple check box subset selection. A user is provided with a graphical user interface (GUI) control for a computing device that allows the user to select (or de-select/clear) multiple check boxes in a sequence of check boxes without individually selecting (or de-selecting/clearing) each individual check box in the sequential list. The check boxes may be associated with long lists of items and interaction with a user interface element, such as a scroll bar or other form of user interaction element, may be detected to facilitate display of additional elements of a given sequential list. In response to user interaction with a first check box via a user input device, the computing device detects a first GUI event associated with this selection. The GUI event may be either a selection event or a de-selection/clear event. Upon detection of a second identical check box GUI event (e.g., either a selection or de-selection/clear event, respectively) associated with a second check box that is not adjacent to the original check box, whether displayed in association with the first check box or after display of the second check box in response to further GUI navigational event detection, a GUI selection control element is displayed. The GUI selection control element prompts the user to select the GUI selection control element if the user wishes the computing device to generate GUI events identical to the first and second GUI events for all of the check boxes between the first and second check box. For purposes of the present subject matter, the terms “de-select,” “de-selected,” and “de-selecting” may be used interchangeably with terms such as “clear,” “cleared,” and “clearing,” respectively, including variations of these terms, to refer to an act or condition of a check box being cleared (e.g., not checked).

It should be noted that detection of the second identical check box GUI event may be performed in association with a same displayed portion of a sequential list of elements as the first check box. Alternatively, detection of the second identical check box GUI event may be performed after detection of user interaction with an additional user interface element, such as a scroll bar, “Page Down” key press detection, “Page Up” key press detection, or other intervening navigational or other event. As such, user interact with a given user interface to perform other navigational or other tasks may be detected and filtered to make the respective determinations of the first and second identical GUI event associated with a list of elements with associated check boxes. Accordingly, the detected GUI events may be separated by other intervening events without departure from the scope of the present subject matter. As such, large collections of items may be broken up into multiple pages for display or performance reasons to further enhance utility of the present subject matter.

It should further be noted that no augmenter (e.g,. “shift” or “control” key) operation is required to be performed by the user for implementation of the multiple check box subset selection described herein. As such, the present subject matter allows a user to interact with a displayed list of elements and to achieve multiple selections or de-selections of a subset of the displayed list of elements without requiring use of an augmenter key and without requiring a selection or de-selection of each element in the subset of the displayed list.

The GUI selection control element may include any GUI element that may be selected by a user input device, such as a mouse, keyboard, etc. For example, the GUI selection control element may include a hypertext link, a button, or any other GUI element. The GUI selection control element may be linked to a command for programmatically generating the GUI event identical to each of the first and second GUI events in response to detection of a selection of the GUI selection control element via the user input device. As an additional example, when the GUI selection control element is implemented as a hypertext link, the hypertext link may be displayed within a hovered GUI object displayed over a list of elements with associated check boxes. However, it is understood that a button or any other GUI element may also be displayed within a hovered GUI object without departure from the scope of the present subject matter. When the computing device detects that the user has selected the hypertext link, the associated command is executed and GUI events identical to the first and second GUI events for the relevant check boxes between the first and second check box are generated to select (or de-select) those check boxes. Many other possibilities exist for display of a GUI selection control element, such as for example, a selectable icon or other displayed GUI element. As such, all such possibilities are considered within the scope of the present subject matter.

As an additional variation, the GUI selection control element may be displayed only when one or more intervening check boxes are in a state that may be changed to the identical state of the first and second GUI events. In such an implementation, where a first and second GUI event are detected that are identical and one or more intervening check boxes exist, the present state of the intervening check box(es) may be determined When it is determined that all intervening check boxes are already in a state identical to a state represented by the first and second GUI events, processing may continue without display of the GUI selection control element. However, where at least one intervening check box is in a state opposite a state represented by the first and second GUI events, the GUI selection control element may be displayed and processing may be performed to execute the command for programmatically generating the GUI event identical to each of the first and second GUI events. Many other variations on processing for determining whether to display the GUI selection control element are possible and all are considered within the scope of the present subject matter.

A configured threshold time for initiating display of the GUI selection control element may be configured to regulate display of the GUI selection control element. A timing device (e.g. a timer, a clock, etc.) may be utilized by the computing device to measure, for example, an elapsed time since a detection of a second GUI event without an intervening other GUI check box selection (e.g., select or clear) event. In such a situation, where the elapsed time exceeds the configured threshold time for initiating display of the GUI selection control element, the GUI selection control element may be displayed to allow the user to select the GUI selection control element to initiate the command execution described above. As such, a user may configure the computing device to provide the described functionality based upon the configured threshold to allow initiation of display of the GUI selection control element to be configured by the user.

A configured threshold time for display of the GUI selection control element may also be configured to regulate duration of display of the GUI selection control element. The timing device may also be used to measure the duration of display time after initiation of the display of the GUI selection control element. In such a situation, where the elapsed time exceeds the configured threshold time for display of the GUI selection control element, display of the GUI selection control element may be terminated to avoid obstructing the user's view of the list items. As such, a user may configure the computing device to provide the described functionality based upon the configured threshold to allow termination of display of the GUI selection control element to be configured by the user.

It should further be noted that the computing device may also be configured to allow “implicit” selection and detection of check box list items. Implicit selection detection by the computing device provides for detection of user selections of either a list item itself or an associated check box to be considered a selection of the check box. Implicit selection may provide flexibility for a user of a computing device in association with selection activities. As such, the processing described herein may be implemented and used in association with a computing device configured to detect and operate using implicit selection and detection.

Based upon the multiple check box subset selection described herein, user interface processing may be expedited by not requiring the user to select each desired check box in a series of check boxes. Further, the user may make this determination during a selection activity rather than being required to review an entire list of items prior to making selections. Use of navigational or other controls may also be detected and filtered to allow long collections of elements to be processed rather than requiring a user to require to review an entire list of items prior to making selections. Additionally, where multiple sequential selections are desired, the user is not required to make each individual selection, and is not required to perform a “select all” activity and then de-select items that are not of interest. Each of these latter alternatives limits a user's ability to progress rapidly through a check box selection sequence and slows user interaction with a GUI of a computing device.

The multiple check box subset selection described herein may be performed in real time to allow prompt control of selection for multiple check boxes. For purposes of the present description, real time shall include any time frame of sufficiently short duration as to provide reasonable response time for information processing acceptable to a user of the subject matter described. Additionally, the term “real time” shall include what is commonly termed “near real time”—generally meaning any time frame of sufficiently short duration as to provide reasonable response time for on-demand information processing acceptable to a user of the subject matter described (e.g., within a portion of a second or within a few seconds). These terms, while difficult to precisely define are well understood by those skilled in the art.

FIG. 1 is a block diagram of an example of an implementation of a computing device 100 for multiple check box subset selection. As will be described in more detail below in association with FIG. 2 through FIG. 9, the computing device 100 provides automated selection and de-selection of sequential check boxes located between two check boxes in a list in response to detection of two identical GUI events (e.g., both either selection or de-selection), where each GUI event is associated with one of the two check boxes. The automated selection and de-selection of sequential check boxes is performed in response to detection of a selection of a displayed GUI selection control element via a user input device. The displayed GUI selection control element may include, for example, a hovered GUI object displayed over a list of check box selections including a hypertext link to a command for programmatically generating an identical GUI event for each of the sequential check boxes located between the two check boxes.

It should be noted that the computing device 100 may be a portable computing device, either by a user's ability to move the computing device 100 to different locations, or by the computing device 100's association with a portable platform, such as a plane, train, automobile, or other moving vehicle. It should also be noted that the computing device 100 may be any computing device capable of processing information as described above and in more detail below. For example, the computing device 100 may include devices such as a personal computer (e.g., desktop, laptop, palm, etc.) or a handheld device (e.g., cellular telephone, personal digital assistant (PDA), email device, music recording or playback device, etc.), or any other device capable of processing information as described in more detail below.

A central processing unit (CPU) 102 provides computer instruction execution, computation, and other capabilities within the computing device 100. A display 104 provides visual information to a user of the computing device 100 and an input device 106 provides input capabilities for the user.

The display 104 may include any display device, such as a cathode ray tube (CRT), liquid crystal display (LCD), light emitting diode (LED), projection, touchscreen, or other display element or panel. The input device 106 may include a computer keyboard, a keypad, a mouse, a pen, a joystick, or any other type of input device by which the user may interact with and respond to information on the display 104. It is further understood that multiple individual input devices may be associated with the computing device 100 and that individual input actions described herein may be generated by different individual input devices without departure from the scope of the present subject matter.

A communication module 108 provides interconnection capabilities that allow the computing device 100 to communicate with other modules within the system 100, such as one or more servers and other computing devices (not shown). The communication module 108 may connect to one or more servers or other computing devices to access information, such as via a network (not shown) that may include any form of interconnection suitable for the intended purpose, including a private or public network such as an intranet or the Internet, respectively, direct inter-module interconnection, dial-up, wireless, or any other interconnection mechanism capable of interconnecting the respective devices. The information accessed by the communication device 108 may include, for example, web pages, client-server applications, or other information sources. These information sources may include graphical user interfaces for display of options and related information that may be selected by the user via an input device, such as the input device 106. The options may be organized in a list or other format with check boxes for use to select the various options. The computing device 100 may detect these selections, as described above and in more detail below, to implement the present subject.

The communication module 108 may include any electrical, protocol, and protocol conversion capabilities useable to provide the interconnection capabilities. Though the communication module 108 is illustrated as a component-level module for ease of illustration and description purposes, it should be noted that the communication module 108 may include any hardware, programmed processor(s), and memory used to carry out the functions of the communication module 108 as described above and in more detail below. For example, the communication module 108 may include additional controller circuitry in the form of application specific integrated circuits (ASICs), processors, antennas, and/or discrete integrated circuits and components for performing communication and electrical control activities associated with the communication module 108. Additionally, the communication module 108 may include interrupt-level, stack-level, and application-level modules as appropriate. Furthermore, the communication module 108 may include any memory components used for storage, execution, and data processing for performing processing activities associated with the communication module 108. The communication module 108 may also form a portion of other circuitry described without departure from the scope of the present subject matter.

A memory 110 includes a graphical user interface (GUI) control information storage area 112 that stores information associated with the multiple check box subset selection described herein. As will be described in more detail below, GUI control information stored within the GUI control information storage area 112 is used, for example, to store an indication of detection of a sequence of non-adjacent GUI selections (e.g., events) associated with a list of selectable items with associated check boxes. The GUI control information may further store an indication of detection that a second GUI event is identical to a penultimate GUI event (e.g., both select events or both de-select events). The GUI control information may further store configuration information associated with configured thresholds for display of a GUI selection control element to allow the computing device 100 to store configuration information. Many other possibilities exist for storing information associated with multiple check box subset selection.

It is understood that the memory 110 may include any combination of volatile and non-volatile memory suitable for the intended purpose, distributed or localized as appropriate, and may include other memory segments not illustrated within the present example for ease of illustration purposes. For example, the memory 110 may include a code storage area, a code execution area, and a data area without departure from the scope of the present subject matter.

A selection processing module 114 is also illustrated. The selection processing module 114 provides GUI selection processing for the computing device 100, as described above and in more detail below. The selection processing module 114 implements the automated multiple check box subset selection of the computing device 100.

Though the selection processing module 114 is illustrated as a component-level module for ease of illustration and description purposes, it should be noted that the selection processing module 114 may include any hardware, programmed processor(s), and memory used to carry out the functions of this module as described above and in more detail below. For example, the selection processing module 114 may include additional controller circuitry in the form of application specific integrated circuits (ASICs), processors, and/or discrete integrated circuits and components for performing communication and electrical control activities associated with the respective devices. Additionally, the selection processing module 114 may also include interrupt-level, stack-level, and application-level modules as appropriate. Furthermore, the selection processing module 114 may include any memory components used for storage, execution, and data processing for performing processing activities associated with the module.

It should also be noted that the selection processing module 114 may form a portion of other circuitry described without departure from the scope of the present subject matter. Further, the selection processing module 114 may alternatively be implemented as an application stored within the memory 110. In such an implementation, the selection processing module 114 may include instructions executed by the CPU 102 for performing the functionality described herein. The CPU 102 may execute these instructions to provide the processing capabilities described above and in more detail below for the computing device 100. The selection processing module 114 may form a portion of an interrupt service routine (ISR), a portion of an operating system, a portion of a browser application, or a portion of a separate application without departure from the scope of the present subject matter.

A timer/clock module 116 is illustrated and used to determine timing for synchronization of activities associated with multiple check box subset selection. As such, for purposes of the present subject matter the timer/clock module 116 may be considered a timing device for use in determining timing relationships between events or between an event and a configured threshold, as appropriate for the given implementation. For example, the timer/clock module 116 may be used to determine an elapsed time since a detection of a subsequent GUI event identical to a penultimate GUI event without an intervening other GUI event, and may be used to determine an elapsed time since display of a GUI selection control element without an intervening GUI event. As such, the selection processing module 114 may utilize information derived from the timer/clock module 116 for synchronization of activities associated with multiple check box subset selection, as described in more detail below.

The CPU 102, the display 104, the input device 106, the communication module 108, the memory 110, the selection processing module 114, and the timer/clock module 116 are interconnected via an interconnection 118. The interconnection 118 may include a system bus, a network, or any other interconnection capable of providing the respective components with suitable interconnection for the respective purpose.

While the computing device 100 is illustrated with and has certain components described, other modules and components may be associated with the computing device 100 without departure from the scope of the present subject matter. Additionally, it should be noted that, while the computing device 100 is described as a single device for ease of illustration purposes, the components within the computing device 100 may be co-located or distributed and interconnected via a network without departure from the scope of the present subject matter. For a distributed arrangement, the display 104 and the input device 106 may be located at a point of sale device, kiosk, or other location, while the CPU 102 and memory 110 may be located at a local or remote server. Many other possible arrangements for components of the computing device 100 are possible and all are considered within the scope of the present subject matter. Accordingly, the computing device 100 may take many forms and may be associated with many platforms.

FIG. 2 through FIG. 7 below represent example GUI interface components in various stages of processing based upon the multiple check box subset selection associated with the present subject matter. FIG. 2 through FIG. 4 represent example processing for selection of multiple check boxes based upon the multiple check box subset selection associated with the present subject matter. FIG. 5 through FIG. 7 described further below represent example processing for de-selection of multiple check boxes based upon the multiple check box subset selection associated with the present subject matter. Many other variations on the example GUI interface components are possible and all are considered within the scope of the present subject matter.

FIG. 2 is an illustration of example of an implementation of an email graphical user interface (GUI) 200 that includes a listing of received emails in an initial state of processing where all list elements are de-selected (e.g., cleared). As can be seen from FIG. 2, the email GUI 200 includes a sender column 202 and a subject column 204. A scrollbar and associated control elements 206 depicts that more elements are available for display within the email GUI 200 than are presently displayed within the email GUI 200. It is understood that the scrollbar and associated control elements 206 may be interacted with by a user via a user input device, such as the input device 106 in the form of a mouse device, for example, to scroll displayable elements within email GUI 200.

Depicted within the example email GUI 200 is a portion of a list of received emails including a check box 208 through a check box 220. As can be seen from FIG. 2, each of the check box 208 through the check box 220 represent a selection element associated with an email received from a different sender identified within the sender column 202. A user may interact with any of the check box 208 through the check box 220 via the input device 106, such as a mouse device, to either request selection or to request de-selection of the respective email from the respective sender.

It should be understood that the computing device 100 may be configured to detect these selection interactions and process them accordingly to show a “check” in the respective check box element and to perform processing in response to the detection, as described above and in more detail below. For purposes of the present subject matter a detected interaction with one of the check box 208 through the check box 220 may be considered an “explicit” selection event. It should further be understood that the computing device 100 may be configured to provide “implicit” selection detection. For an implementation utilizing implicit selection of list items, the computing device 100 may be configured to detect interaction by the input device 106 with any portion of a list element associated with respective check box and perform either a selection or a de-selection operation for the associated check box element without requiring the user to navigate a GUI component, such as a cursor (not shown), into close proximity of the respective check box element to indicate a request to select or de-select the respective check box.

FIG. 3 is an illustration of an example of an implementation of the email GUI 200 of FIG. 2 in a subsequent state of processing after the computing device 100 has detected two identical GUI selection events associated with the email GUI 200. Within FIG. 3, the check box 208 and the check box 214 are shown with a “check” in each of the check box elements. For purposes of the present subject matter, there is no limitation on the order of operations by the user and associated detection of selection events. As such, detection of a GUI selection event for either the check box 208 or the check box 214 may be made prior to the other without departure from the scope of the present subject matter.

Accordingly, detection of the GUI selection event associated with either the check box 208 or the check box 214 may be considered the penultimate selection and the other may be considered the second selection. Further, it should be noted that for purposes of the present subject matter, the GUI selection event associated with each of the check box 208 and the check box 214 are considered “identical” GUI selection events because they each represent a “selection” event. Similarly, two GUI de-selection events may be considered “identical” GUI selection events for purposes of the present subject matter. As such, multiple GUI selection events and de-selection events may occur before two successive identical GUI events are detected and processed.

Additionally, neither the intermediate check box 210 nor the intermediate check box 212 is selected. In response to detection of a GUI selection event associated with the second of the two identical GUI selection events with at least one intermediate check box associated with the displayed list of elements, the computing device 100 displays a GUI selection control element 222 associated with the at least one other check box element. As can be seen from FIG. 3, the GUI selection control element 222 includes a hypertext link 224. The computing device 100 programmatically generates a GUI event identical to each of the penultimate GUI event (e.g., either the event associated with the check box 208 or the check box 214 based upon the order of selection) and the second GUI event for the other intermediate check box element(s) in response to detection of a selection of the GUI selection control element 222 and/or the hypertext link 224 via the input device 106.

FIG. 4 is an illustration of an example of an implementation of the email GUI 200 of FIG. 3 in a subsequent state of processing after the computing device 100 has detected a selection of the GUI selection control element 222 illustrated within FIG. 3. Within FIG. 4, it can be seen that the check box 210 and the check box 212 have a “check” associated with the respective check box elements. This processing was performed automatically by the computing device 100 in response to detection of a selection associated with the GUI selection control element 222 and/or the hypertext link 224 via the input device 106. As such, the user was not required to select each individual check box element, either explicitly or implicitly, to indicate a request to select the intermediate check box elements. Additionally, the user was prompted to indicate this request to select the intermediate check box elements by display of the GUI selection control element 222 and the hypertext link 224. As described above and in more detail below, display of the GUI selection control element 222 and the hypertext link 224 may be based upon configured thresholds for display and termination of display of the respective GUI elements. Many other variations on the example email GUI 200 and the depicted example processing are possible and all are considered within the scope of the present subject matter.

As described above, FIG. 5 through FIG. 7 represent example processing for de-selection of multiple check boxes based upon the multiple check box subset selection associated with the present subject matter. Many other variations on the example GUI interface components are possible and all are considered within the scope of the present subject matter.

FIG. 5 is an illustration of an example of an implementation of the email GUI 200, originally depicted in FIG. 2, that includes a listing of received emails in an initial state of processing where all list elements are selected. As can be seen from FIG. 5, the check box 208 through the check box 220 are depicted in a selected state. Reference may be made to the description of FIG. 2 through FIG. 4 for further details of the example email GUI 200.

FIG. 6 is an illustration of an example of an implementation of the email GUI 200 of FIG. 5 in a subsequent state of processing after the computing device 100 has detected two identical GUI de-selection (e.g., clear) events associated with the email GUI 200. Within FIG. 6, the check box 208 and the check box 214 are shown without a “check” in each of the check box elements. For purposes of the present subject matter, there is no limitation on the order of operations by the user and associated detection of de-selection events. As such, detection of a GUI de-selection event for either the check box 208 or the check box 214 may be made prior to the other without departure from the scope of the present subject matter.

Accordingly, detection of the GUI de-election event associated with either the check box 208 or the check box 214 may be considered the penultimate selection and the other may be considered the second selection. Further, it should be noted that for purposes of the present subject matter, the GUI de-selection event associated with each of the check box 208 and the check box 214 are considered “identical” GUI selection events because they each represent a “de-selection” event. As such, multiple GUI selection and de-selection events may occur before two successive identical GUI events are detected and processed.

Additionally, neither the intermediate check box 210 nor the intermediate check box 212 is de-selected. In response to detection of a GUI de-selection event associated with the second of the two identical GUI de-selection events with at least one intermediate check box associated with the displayed list of elements, the computing device 100 displays a GUI selection control element 226 associated with the at least one other check box element. As can be seen from FIG. 6, the GUI selection control element 226 includes a hypertext link 228. The computing device 100 programmatically generates a GUI event identical to each of the penultimate GUI event (e.g., either the event associated with the check box 208 or the check box 214 based upon the order of de-selection) and the second GUI event for the other intermediate check box element(s) in response to detection of a selection of the GUI selection control element 226 and/or the hypertext link 228 via the input device 106.

FIG. 7 is an illustration of an example of an implementation of the email GUI 200 of FIG. 6 in a subsequent state of processing after the computing device 100 has detected a selection of the GUI selection control element 226 illustrated within FIG. 6. Within FIG. 7, it can be seen that the check box 210 and the check box 212 do not have a “check” associated with the respective check box elements. As such, the respective check box elements have been automatically cleared. This processing was performed automatically by the computing device 100 in response to detection of a selection associated with the GUI selection control element 226 and/or the hypertext link 228 via the input device 106. As such, the user was not required to de-select each individual check box element, either explicitly or implicitly, to indicate a request to de-select the intermediate check box elements. Additionally, the user was prompted to indicate this request to de-select the intermediate check box elements by display of the GUI selection control element 226 and the hypertext link 228. As described above and in more detail below, display of the GUI selection control element 226 and the hypertext link 228 may be based upon configured thresholds for display and termination of display of the respective GUI elements. Many other variations on the example email GUI 200 and the depicted example processing are possible and all are considered within the scope of the present subject matter.

FIG. 8 through FIG. 9 below describe example processes that may be executed by devices, such as the computing device 100, to perform the automated multiple check box subset selection associated with the present subject matter. Many other variations on the example processes are possible and all are considered within the scope of the present subject matter. The example processes may be performed by modules, such as the selection processing module 114 and/or executed by the CPU 102, associated with such devices. It should be noted that time out procedures and other error control procedures are not illustrated within the example processes described below for ease of illustration purposes. However, it is understood that all such procedures are considered to be within the scope of the present subject matter.

FIG. 8 is a flow chart of an example of an implementation of a process 800 for automated multiple check box subset selection. At block 802, the process 800 displays a list of elements, each with an associated check box element, via a graphical user interface (GUI) component on a display device. At block 804, the process 800 detects a first GUI event associated with one check box element, where the first GUI event comprises a GUI event selected from a group consisting of a check box selection event and a check box clear event. At block 806, the process 800 detects a second GUI event identical to the first GUI event associated with a second check box element, where at least one other check box element is displayed between the one check box element and the second check box element via the GUI component. At block 808, the process 800 displays a GUI selection control element. At block 810, the process 800 programmatically generates a GUI event identical to each of the first GUI event and the second GUI event for the at least one other check box element in response to detection of a selection of the GUI selection control element via an input device.

FIG. 9 is a flow chart of an example of an implementation of a process 900 for multiple check box subset selection without requiring use of an augmenter key. At decision point 902, the process 900 makes a determination as to whether a request to display a list of elements via a graphical user interface (GUI) component on a display device, such as the display 104, has been detected. Detection of the request to display the list elements may be performed, for example, in response to opening of an application via the computing device 100 (e.g., an email application, similar to the email GUI 200 described above).

In response to detection of a request to display a list of elements, the process 900 displays a list of elements, each with an associated check box element, via a GUI component on the display 104 at block 904. At decision point 906, the process 900 makes a determination as to whether a GUI event has been detected. As described above, for purposes of the present subject matter, GUI events may be detected and processed as they occur. Further, GUI events may be generated via a user input device, such as the input device 106. The processing described below iterates until two identical GUI events are detected. As such, the processing associated with the determination at decision point 906 may be considered processing to identify a penultimate GUI event.

It should further be noted, as described above, that the GUI event may include an explicit GUI event or an implicit GUI event. As such, detecting the GUI event generated via the user input device 106 associated with the check box element may include either an explicit GUI event associated with the respective check box element or may include detection of a GUI event associated with a selection of the list element of the displayed list of elements associated with the respective check box element via the input device 106. Further, detecting a GUI event generated via the user input device 106 associated with a second or subsequent check box element may include either an explicit GUI event associated with the respective check box element or may include detection of a GUI event associated with a selection of the list element of the displayed list of elements associated with the second check box element via the input device 106.

Returning to a description of decision point 906, when a determination is made that a GUI event has been detected at decision point 906, the process 900 makes a determination at decision point 908 as to whether the detected GUI event is a selection GUI event or a de-selection GUI event, associated with one of the display check boxes associated with the display list elements. When a determination is made that the detected GUI event is a selection GUI event at decision point 908, the process 900 selects the associated check box (e.g., by displaying a “check” within the respective check box) at block 910. When a determination is made that the detected GUI event is a de-selection GUI event, the process 900 de-selects the associated check box (e.g., terminates display of a “check” within the respective check box) at block 912. The process 900 proceeds to decision point 914 after either selecting the associated check box at block 910 or after de-selecting the associated check box at block 912.

At decision point 914, the process 900 makes a determination as to whether a subsequent (e.g., a second or further subsequent) GUI event has been detected. For purposes of the present portion of this description, the subsequent GUI event shall be considered the “current” GUI event. Further, as described above, the detected GUI events may be explicit or implicit GUI events associated with the respective check box elements.

When a determination is made that a subsequent GUI event has been detected, the process 900 makes a determination at decision point 916 as to whether at least one list element is located between the penultimate GUI event detected (e.g., at decision point 906) and the respective subsequent GUI event detected at decision point 914. When a determination is made that at least one list element is not located between the penultimate GUI event detected and the respective subsequent (e.g., current) GUI event detected, the process 900 returns to decision point 908 to make a determination as to whether the detected subsequent GUI event is a selection GUI event or a de-selection GUI event, and continues processing as described above. It should also be noted that the processing to return to decision point 908 causes the subsequent GUI event (e.g., the current GUI event) to become the first GUI event for purposes of the processing described to determine whether the current GUI event shall be considered a penultimate identical GUI event for subsequent processing, as described in more detail below.

Returning to the description of decision point 916, when a determination is made that at least one list element is located between the penultimate GUI event detected and the respective subsequent GUI event detected, the process 900 makes a determination at decision point 918 as to whether the penultimate GUI event detected and the respective subsequent GUI event detected are identical GUI events (e.g., either both selection GUI events or both de-selection GUI events).

When a determination is made at decision point 918 that the penultimate GUI event detected and the respective subsequent GUI event detected are not identical GUI events, the process 900 returns to decision point 908 to continue processing as described above. Again, it should be noted that the processing to return to decision point 908 causes the subsequent GUI event (e.g., the current GUI event) to become the first GUI event for purposes of the processing described to determine whether the current GUI event shall be considered a penultimate identical GUI event for subsequent processing, as described in more detail below.

When a determination is made at decision point 918 that the penultimate GUI event detected and the respective subsequent GUI event detected are identical GUI events, the process 900 retrieves display threshold times for display and termination of display of a GUI selection control element at block 920. At block 922, the process 900 starts a timing device, such as the timer/clock module 116.

For purposes of the present subject matter, any suitable threshold times for display and termination of display of a GUI selection control element may be used. Though not considered limiting, one example configured threshold time for display of the GUI selection control element may include approximately a seven hundred and fifty millisecond (750 ms) configured threshold time for display of the GUI selection control element. Further, a configured termination threshold time for display of the GUI selection control element after it is displayed may include, for example, approximately two (2) seconds.

As such, the GUI selection control element may not be displayed until approximately 750 ms have elapsed from the time of the subsequent GUI event to allow the user to make an additional selection without display of the GUI selection control element interfering with an additional selection. Further, display of the GUI present example. However, it should be noted that these example times of 750 ms for display and 2 seconds for termination of display may be changed as appropriate for a given implementation. These threshold times may further be configured by the user to allow a range of configured threshold times to be available. For example, the configured threshold time for display of the GUI selection control element may range from five hundred milliseconds (500 ms or ½ second) to 1500 milliseconds (1500 ms or 1.5 seconds) or more without departure from the scope of the present subject matter. Further, the configured threshold time for termination of display of the GUI selection control element may range from five hundred milliseconds (500 ms or ½ second) to ten (10) or more seconds without departure from the scope of the present subject matter. Accordingly, a variety of configuration options may be made available as appropriate for a given implementation.

At decision point 924, the process 900 makes a determination as to whether an elapsed time since the detection of the second GUI event identical to the first GUI event without an intervening other GUI event exceeds a configured threshold time for initiating display of the GUI selection control element. When a determination is made that the elapsed time has not exceeded the configured threshold time for initiating display of the GUI selection control element, the process 900 makes a determination at decision point 926 as to whether an intervening GUI selection (e.g., select or clear) event has occurred. It should be noted, as described above, that other intervening events, such as navigation or other events (e.g., scroll bar navigation events, “Page Down” key event, “Page Up” key event, etc.), may be detected and filtered to allow the determination as to whether an intervening GUI selection event has occurred.

When a determination is made that an intervening GUI selection event has occurred, the process 900 returns to decision point 908 and iterates as described above. When a determination is made that an intervening GUI selection event has not occurred, the process 900 returns to decision point 924 to determine whether the elapsed time has exceeded the configured time for initiating display of the GUI selection control element.

When a determination is made at decision point 924 that the elapsed time has exceeded the configured time for initiating display of the GUI selection control element without an intervening GUI event, the process 900 displays the GUI selection control element at block 928. As described above in association with FIG. 2 through FIG. 7, displaying the GUI selection control element associated with the at least one other check box element may include displaying a hovered GUI object over the displayed list of elements that includes a hypertext link to a command for programmatically generating the GUI event identical to each of the penultimate GUI event and the subsequent GUI event in response to detection of a selection of the hypertext link via the user input device 106.

At decision point 930, the process 900 makes a determination as to whether a configured termination threshold time for display of the GUI selection control element has been exceeded. When a determination is made that the configured termination threshold time for display of the GUI selection control element has been exceeded, the process 900 terminates display of the GUI selection control element, at block 932, in response to determining that the elapsed time since the display of the GUI selection control element without the intervening other GUI event exceeds the configured termination threshold time for display of the GUI selection control element. The process 900 returns to decision point 908 and iterates as described above.

When a determination is made at decision point 930 that the configured termination threshold time for display of the GUI selection control element has not been exceeded, the process 900 makes a determination at decision point 934 as to whether a selection event associated with the GUI selection control element has been detected. When a determination is made that a selection event associated with the GUI selection control element has not been detected, the process 900 returns to decision point 930 and iterates as described above.

When a determination is made at decision point 934 that a selection event associated with the GUI selection control element has been detected, the process 900 programmatically generates a GUI event identical to each of the penultimate GUI event and the subsequent GUI event for the at least one other check box element at block 936 in response to detection of a selection of the GUI selection control element via the user input device 106. This processing may be performed, for example, by executing a command for programmatically generating the GUI event identical to each of the penultimate GUI event and the subsequent GUI event in response to detection of a selection of a GUI selection control element event, such as detection of a selection of a hypertext link, button, or other GUI selection control element, via the user input device 106 associated with the GUI selection control element.

At decision point 938, the process 900 makes a determination as to whether to terminate display of the list of elements. This determination may be made, for example, in response to detection of a selection of an “OK” or “Enter” button associated with a graphical user interface component within which a list is display, or in response to detection of a request to close an application such as an email GUI application or in response to detection of some other event indicative of a request to terminate display of the list of elements. Many other possibilities exist for processing associated with a determination at decision point 938 and all are considered within the scope of the present subject matter. However, it is understood that the process 900 may return to decision point 906 to determine whether a GUI selection event has been detected as many times as appropriate for a given implementation.

When a determination is made not to terminate display of the list of elements, the process 900 returns to decision point 906 to await identification of a new penultimate GUI event. When a determination is made to terminate display of the list of elements, the process 900 returns to decision point 902 to await a new request to display a new list of elements via a GUI component on a display device, such as the display 104, to be detected.

As such, the process 900 provides for detection and processing of GUI events associated with a list of displayed elements. The GUI events may be either explicit GUI events or implicit GUI events. The process 900 iteratively identifies a penultimate GUI event and a subsequent GUI event identical to the penultimate GUI event. The process 900 processes configured time thresholds for display and termination of display of a GUI selection control element, and executes an associated command in response to detection of a selection of the GUI selection control element to select or de-select intermediate check boxes to place those intermediate check boxes into a state identical to the penultimate and subsequent GUI events. Accordingly, the process 900 allows a user to interact with a displayed list of elements and, in response to detection of sequences of identical events, performs multiple selections or de-selections of a subset of the displayed list of elements without requiring use of an augmenter key and without requiring a selection or de-selection of each element in the subset of the displayed list.

As described above in association with FIG. 1 through FIG. 9, the example systems and processes provide multiple check box subset selection. Many other variations and additional activities associated with multiple check box subset selection are possible and all are considered within the scope of the present subject matter.

Those skilled in the art will recognize, upon consideration of the above teachings, that certain of the above examples are based upon use of a programmed processor, such as the CPU 102. However, the invention is not limited to such example embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable storage medium that can direct a computer or other programmable data processing apparatus to function in a particular manner, such that the instructions stored in the computer-readable storage medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
displaying a list of elements, each with an associated check box element, via a graphical user interface (GUI) component on a display device;
detecting a first GUI event associated with one check box element, where the first GUI event comprises a GUI event selected from a group consisting of a check box selection event and a check box clear event;
detecting a second GUI event identical to the first GUI event associated with a second check box element, where at least one other check box element is displayed between the one check box element and the second check box element via the GUI component;
displaying a GUI selection control element; and
programmatically generating a GUI event identical to each of the first GUI event and the second GUI event for the at least one other check box element in response to detection of a selection of the GUI selection control element via a user input device.

2. The method of claim 1, further comprising:
starting a timing device upon detection of the second GUI event identical to the first GUI event;
determining whether an elapsed time since the detection of the second GUI event identical to the first GUI event without an intervening other GUI event exceeds a configured threshold time for initiating display of the GUI selection control element; and
where displaying the GUI selection control element comprises displaying the GUI selection control element in response to determining that the elapsed time since the detection of the second GUI event identical to the first GUI event without the intervening other GUI event exceeds the configured threshold time for initiating display of the GUI selection control element.

3. The method of claim 2, where the configured threshold time for display of the GUI selection control element comprises approximately a seven hundred and fifty millisecond (750 ms) configured threshold time and further comprising determining that the elapsed time since the detection of the second GUI event identical to the first GUI event exceeds the approximately 750 ms configured threshold time.

4. The method of claim 1, further comprising:
starting a timing device upon detection of the second GUI event identical to the first GUI event;
determining whether an elapsed time since the display of the GUI selection control element without an intervening other GUI event exceeds a configured termination threshold time for display of the GUI selection control element; and
terminating display of the GUI selection control element in response to determining that the elapsed time since the display of the GUI selection control element without the intervening other GUI event exceeds the configured termination threshold time for display of the GUI selection control element.

5. The method of claim 3, where the configured termination threshold time for display of the GUI selection control element comprises approximately a two (2) second configured threshold time and further comprising determining that the elapsed time since the display of the GUI selection control element without the intervening other GUI event exceeds the approximately 2 second configured threshold time.

6. The method of claim 1, where displaying the GUI selection control element comprises displaying a hovered GUI object over at least a portion of the displayed list of elements comprising a hypertext link to a command for programmatically generating the GUI event identical to each of the first GUI event and the second GUI event for the at least one other check box element in response to detection of a selection of the hypertext link via the user input device.

7. The method of claim 1, where at least one of the first GUI event and the second GUI event identical to the first GUI event comprises an implicit GUI event, and where:
in response to the first GUI event comprising the implicit GUI event, detecting the first GUI event associated with the one check box element comprises detecting a GUI event associated with a selection of a list element of the displayed list of elements, associated with the one check box element via the user input device; and
in response to the second GUI event identical to the first GUI event comprising the implicit GUI event, detecting the second GUI event identical to the first GUI event associated with a second check box element comprises detecting a GUI event associated with a selection of a list element, of the displayed list of elements, associated with the second check box element via the user input device.

8. A system, comprising:
a display device;
a user input device; and
a processor programmed to:
display a list of elements, each with an associated check box element, via a graphical user interface (GUI) component on the display device;
detect a first GUI event associated with one check box element, where the first GUI event comprises a GUI event selected from a group consisting of a check box selection event and a check box clear event;
detect a second GUI event identical to the first GUI event associated with a second check box element, where at least one other check box element is displayed between the one check box element and the second check box element via the GUI component;
display a GUI selection control element via the display device; and
programmatically generate a GUI event identical to each of the first GUI event and the second GUI event for the at least one other check box element in response to detection of a selection of the GUI selection control element via the user input device.

9. The system of claim 8, further comprising:
a timing device; and
where the processor is further programmed to:
start the timing device upon detection of the second GUI event identical to the first GUI event; and
determine whether an elapsed time since the detection of the second GUI event identical to the first GUI event without an intervening other GUI event exceeds a configured threshold time for initiating display of the GUI selection control element; and
where, in being programmed to display the GUI selection control element, the processor is programmed to display the GUI selection control element in response to determining that the elapsed time since the detection of the second GUI event identical to the first GUI event without the intervening other GUI event exceeds the configured threshold time for initiating display of the GUI selection control element.

10. The system of claim 9, where the configured threshold time for display of the GUI selection control element comprises approximately a seven hundred and fifty millisecond (750 ms) configured threshold time and where, in being programmed to display the GUI selection control element in response to determining that the elapsed time since the detection of the second GUI event identical to the first GUI event without the intervening other GUI event exceeds the configured threshold time for initiating display of the GUI selection control element, the processor is further programmed to determine that the elapsed time since the detection of the second GUI event identical to the first GUI event exceeds the approximately 750 ms configured threshold time.

11. The system of claim 8, further comprising:
a timing device; and
where the processor is further programmed to:
start the timing device upon detection of the second GUI event identical to the first GUI event;
determine whether an elapsed time since the display of the GUI selection control element without an intervening other GUI event exceeds a configured termination threshold time for display of the GUI selection control element; and
terminate display of the GUI selection control element in response to determining that the elapsed time since the display of the GUI selection control element without the intervening other GUI event exceeds the configured termination threshold time for display of the GUI selection control element.

12. The system of claim 8, where, in being programmed to display the GUI selection control element, the processor is programmed to display a hovered GUI object over at least a portion of the displayed list of elements comprising a hypertext link to a command for programmatically generating the GUI event identical to each of the first GUI event and the second GUI event for the at least one other check box element in response to detection of a selection of the hypertext link via the user input device.

13. The system of claim 8, where at least one of the first GUI event and the second GUI event identical to the first GUI event comprises an implicit GUI event, and where:
in response to the first GUI event comprising the implicit GUI event, in being programmed to detect the first GUI event associated with the one check box element, the processor is programmed to detect a GUI event associated with a selection of a list element of the displayed list of elements, associated with the one check box element via the user input device; and
in response to the second GUI event identical to the first GUI event comprising the implicit GUI event, in being programmed to detect the second GUI event identical to the first GUI event associated with a second check box element, the processor is programmed to detect a GUI event associated with a selection of a list element, of the displayed list of elements, associated with the second check box element via the user input device.

14. A computer program product comprising a computer readable storage medium including computer readable program code, wherein the computer readable program code when executed on a computer causes the computer to:
display a list of elements, each with an associated check box element, via a graphical user interface (GUI) component on a display device;
detect a first GUI event associated with one check box element, where the first GUI event comprises a GUI event selected from a group consisting of a check box selection event and a check box clear event;
detect a second GUI event identical to the first GUI event associated with a second check box element, where at least one other check box element is displayed between the one check box element and the second check box element via the GUI component;
display a GUI selection control element via the display device; and
programmatically generate a GUI event identical to each of the first GUI event and the second GUI event for the at least one other check box element in response to detection of a selection of the GUI selection control element via a user input device.

15. The computer program product of claim 14, where the computer readable program code when executed on the computer further causes the computer to:
start a timing device upon detection of the second GUI event identical to the first GUI event;
determine whether an elapsed time since the detection of the second GUI event identical to the first GUI event without an intervening other GUI event exceeds a configured threshold time for initiating display of the GUI selection control element; and
where, in causing the computer to display the GUI selection control element, the computer readable program when executed on the computer causes the computer to display the GUI selection control element in response to determining that the elapsed time since the detection of the second GUI event identical to the first GUI event without the intervening other GUI event exceeds the configured threshold time for initiating display of the GUI selection control element.

16. The computer program product of claim 15, where the configured threshold time for display of the GUI selection control element comprises approximately a seven hundred and fifty millisecond (750 ms) configured threshold time, and where the computer readable program code when executed on the computer further causes the computer to determine that the elapsed time since the detection of the second GUI event identical to the first GUI event exceeds the approximately 750 ms configured threshold time.

17. The computer program product of claim 14, where the computer readable program code when executed on the computer further causes the computer to:
start a timing device upon detection of the second GUI event identical to the first GUI event;
determine whether an elapsed time since the display of the GUI selection control element without an intervening other GUI event exceeds a configured termination threshold time for display of the GUI selection control element; and
terminate display of the GUI selection control element in response to determining that the elapsed time since the display of the GUI selection control element without the intervening other GUI event exceeds the configured termination threshold time for display of the GUI selection control element.

18. The computer program product of claim 14, where the configured termination threshold time for display of the GUI selection control element comprises approximately a two (2) second configured threshold time, and where the computer readable program code when executed on the computer further causes the computer to determine that the elapsed time since the display of the GUI selection control element without the intervening other GUI event exceeds the approximately 2 second configured threshold time.

19. The computer program product of claim 14, where, in causing the computer to display the GUI selection control element, the computer readable program when executed on the computer causes the computer to display a hovered GUI object over at least a portion of the displayed list of elements comprising a hypertext link to a command for programmatically generating the GUI event identical to each of the first GUI event and the second GUI event for the at least one other check box element in response to detection of a selection of the hypertext link via the user input device.

20. The computer program product of claim 14, where at least one of the first GUI event and the second GUI event identical to the first GUI event comprises an implicit GUI event, and where:
in response to the first GUI event comprising the implicit GUI event, in causing the computer to detect the first GUI event associated with the one check box element, the computer readable program when executed on the computer causes the computer to detect a GUI event associated with a selection of a list element of the displayed list of elements, associated with the one check box element via the user input device; and
in response to the second GUI event identical to the first GUI event comprising the implicit GUI event, in causing the computer to detect the second GUI event identical to the first GUI event associated with a second check box element, the computer readable program when executed on the computer causes the computer to detect a GUI event associated with a selection of a list element, of the displayed list of elements, associated with the second check box element via the user input device.
